(19) United States
(12) Patent Application Publication
(10) Pub. No.: US 2025/0075734 A1
(43) Pub. Date: Mar. 6, 2025

(54) DEVICE FOR SLIDING STORAGE BOX FOR VEHICLE

(71) Applicants: Hyundai Motor Company, Seoul (KR); Kia Corporation, Seoul (KR); KBI Dongkook Ind. Co., Ltd., Seoul (KR)

(72) Inventors: Jung Hoon Woo, Suwon (KR); Dae Hee Lee, Incheon (KR); Hong Sik Chang, Hwaseong (KR); Jin Suk Seo, Seoul (KR); Hye Kyung Kim, Suwon (KR); Kwan Woo Lee, Suwon (KR); Dong Yong Choi, Suwon (KR); Dong Il Son, Ulsan (KR); Dong Hyuk Choi, Ulsan (KR); Chang Bok Park, Hwaseong (KR); O Sim Kwon, Ulsan (KR); Sun Kyung Kim, Ulsan (KR)

(21) Appl. No.: 18/638,922

(22) Filed: Apr. 18, 2024

(30) Foreign Application Priority Data
Aug. 31, 2023 (KR) 10-2023-0115215

(51) Int. Cl. F16C 29/00; B60R 7/04; F16C 29/10

(52) U.S. Cl. CPC F16C 29/005; B60R 7/04; F16C 29/10; F16C 2314/72

(57) ABSTRACT

Described is a sliding device allowing a user to switch between an electric sliding mode and a manual sliding mode as needed and including a guide rail module, a sliding rail slidably coupled to the guide rail module, a rail driving module coupled to the sliding rail and configured to move the sliding rail along the guide rail module by driving of a motor, and a sliding mode switching module configured to switch an operation mode of the sliding rail from an electric sliding mode to a manual sliding mode by blocking a driving force of the rail driving module from being transmitted to the sliding rail. The sliding device may be used for sliding a storage box for a vehicle.

### CROSS-REFERENCE TO RELATED APPLICATION

This application claims, under 35 U.S.C. § 119 (a), the benefit of Korean Patent Application No. 10-2023-0115215, filed on Aug. 31, 2023, the entire contents of which are incorporated herein by reference.

### BACKGROUND

### Technical Field

The present disclosure relates to a sliding device for, for example, sliding a storage box for a vehicle, and more particularly to a device for sliding a storage box for a vehicle, the device capable of switching between an electric sliding mode and a manual sliding mode as needed.

### Background

Generally, a vehicle is equipped with a console box, a glove box, an overhead box, etc. each used as an interior storage box, and such storage boxes may be opened and closed depending on user convenience.

The console box is a box-shaped storage space provided between a driver's seat and a front passenger seat and is also called a center console. Because the console box is located between the driver's seat and the front passenger seat, the console box is mainly used to store frequently used items and is also used as an armrest for a driver or a front-seat passenger.

Recently, a console box is mounted to a vehicle body in an electrically movable manner to increase the use of interior space and improve user convenience.

However, a conventional console box is moved by the driving force of a motor, and thus the movement of the console box is limited by the speed of the motor, causing a disadvantage in that it is difficult to move the console box at a user's desired speed.

The above information disclosed in this Background section is only for enhancement of understanding of the background of the present disclosure, and therefore it may contain information that does not form the prior art that is already known to a person of ordinary skill in the art.

### SUMMARY OF THE DISCLOSURE

The present disclosure has been made in an effort to solve the above-described problems associated with the pre-exiting technologies, and it is an object of the present disclosure to provide a device for sliding a storage box for a vehicle, the device configured to allow a user to switch between an electric sliding mode and a manual sliding mode as needed.

The object of the present disclosure is not limited to the foregoing, and other objects not mentioned herein will be clearly understood by those of ordinary skill in the art to which the present disclosure pertains based on the description below.

In one embodiment, the present disclosure provides a device for e.g., sliding a storage box for a vehicle, the device including a guide rail module, a sliding rail slidably coupled to the guide rail module, a rail driving module coupled to the sliding rail and configured to move the sliding rail along the guide rail module by driving of a motor, and a sliding mode switching module configured to switch an operation mode of the sliding rail from an electric sliding mode to a manual sliding mode by blocking the driving force of the rail driving module from being transmitted to the sliding rail.

In an exemplary embodiment, the rail driving module may include a lead screw rotated by the motor, a nut housing coupled to the sliding rail, and a linear-movement nut that is rotatable and adjacent to the sliding rail, and in the manual sliding mode, a rotation of the linear-movement nut is restricted by the sliding mode switching module.

In the electric sliding mode, a rotation of the linear-movement nut may not be interlocked by the sliding mode switching module, and the linear-movement nut may be configured to rotates together with the lead screw.

In another exemplary embodiment, the linear-movement nut may rotate together with the lead screw when the rotation of the linear-movement nut is not restricted by the sliding mode switching module.

In still another exemplary embodiment, the sliding mode switching module may include a rod housing fixed to the sliding rail, a push knob mounted in the rod housing and linearly movable into and out of the rod housing, and a locking rod, connected to the push knob to interlock with the linear movement of the push knob and configured to be detached from or coupled to the linear-movement nut by the linear movement of the push knob.

In yet another exemplary embodiment, the push knob may have formed therein a rod guide hole to guide the vertical movement of the locking rod, and the locking rod may be provided with a rod guide pin configured to move along the rod guide hole by the linear movement of the push knob.

In still yet another exemplary embodiment, the push knob may include a first knob portion protruding out of the rod housing and a second knob portion inserted into the rod housing, and the rod guide hole may be formed in the second knob portion. The rod guide hole may extend to be inclined upward toward the first knob portion.

In a further exemplary embodiment, the linear-movement nut may have formed therein a locking hole into which the locking rod is coupled. The locking rod may have a lower portion provided with a locking protrusion detachably inserted into the locking hole so as not to restrict the rotation of the linear-movement nut while the locking protrusion is detached from the locking hole.

Pushing the push knob into the rod housing may detach the locking protrusion from the locking hole, thereby switching the operation mode of the sliding rail to the manual sliding mode.

In another further exemplary embodiment, the second knob portion and the rod housing may have a return spring therebetween, and the return spring may be compressed as the first knob portion moves into the rod housing.

Releasing the push knob may return the push knob by the return spring, thereby switching the operation mode of the sliding rail to the electric sliding mode.

In still another further exemplary embodiment, the guide rail module may include a guide rail mounted to a vehicle body and configured to guide the movement of the sliding rail, and a guide rail cover configured to cover the guide rail and having formed therein a movement guide hole to allow the sliding rail to move.

In yet another further exemplary embodiment, the sliding rail may have a foreign matter blocking spring coupled thereto, and the foreign matter blocking spring may be configured to close the movement guide hole opened by the movement of the sliding rail.

Other embodiments and exemplary embodiments of the present disclosure are discussed infra.

The above and other features of the present disclosure are discussed infra.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 is an assembled perspective view illustrating a device for sliding a storage box for a vehicle according to an exemplary embodiment of the present disclosure;

FIG. 2 is an exploded perspective view illustrating a sliding device according to an exemplary embodiment of the present disclosure;

FIG. 3 is a view illustrating a portion of a sliding device according to an exemplary embodiment of the present disclosure;

FIG. 4 is a perspective view illustrating a rail driving module and a sliding mode switching module according to an exemplary embodiment of the present disclosure;

FIG. 5 is a plan view illustrating a sliding device according to an exemplary embodiment of the present disclosure;

FIG. 6 is a view from A-A in FIG. 5;

FIG. 7 is a view from B-B in FIG. 5;

FIG. 8 is a view illustrating the unlocking mode of a rail driving module according to an exemplary embodiment of the present disclosure;

FIG. 9 is a view illustrating the unlocking mode of a sliding mode switching module according to an exemplary embodiment of the present disclosure;

FIG. 10 is a view illustrating the power transmission structure of a rail driving module according to an exemplary embodiment of the present disclosure; and

FIG. 11 and FIG. 12 are views illustrating the operation of a foreign matter blocking spring according to an exemplary embodiment of the present disclosure.

It should be understood that the appended drawings are not necessarily to scale, presenting a somewhat simplified representation of various features illustrative of the basic principles of the present disclosure. The specific design features of the present disclosure, including, for example, specific dimensions, orientations, locations, and shapes, will be determined in part by the particular intended application and usage environment.

In the figures, the reference numbers refer to the same or equivalent parts of the present disclosure throughout the several figures of the drawing.

### DETAILED DESCRIPTION

Hereinafter, exemplary embodiments of the present disclosure will be described with reference to the accompanying drawings. The matters described in the attached drawings may be different from those actually implemented in order to facilitate description of the embodiments of the present disclosure.

In this specification, the terms “first,” “second,” etc. may be used to describe various components, but the components are not limited to the terms. These terms are used to distinguish one component from another. For example, without departing from the scope of the present disclosure, a first component may be referred to as a second component, and a second component may be referred to as a first component.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless otherwise specified in this specification, directions such as “up and down,” “left and right,” and “front and rear” are based on the direction of a vehicle.

A device for sliding a storage box for a vehicle according to an exemplary embodiment of the present disclosure is configured to move the storage box (not shown) provided between a driver's seat and a front passenger seat. The sliding device may adjust the position of the storage box or secure a space between the driver's seat and the front passenger seat by moving the storage box. The storage box has a storage space for storing items and is also used as an armrest for a user. The sliding device is provided between the storage box and the vehicle body and is configured to allow the storage box to move in a sliding manner.

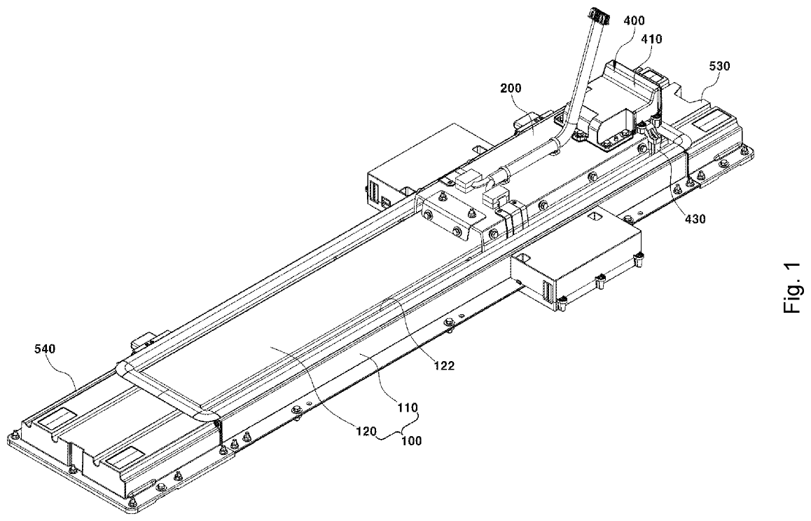

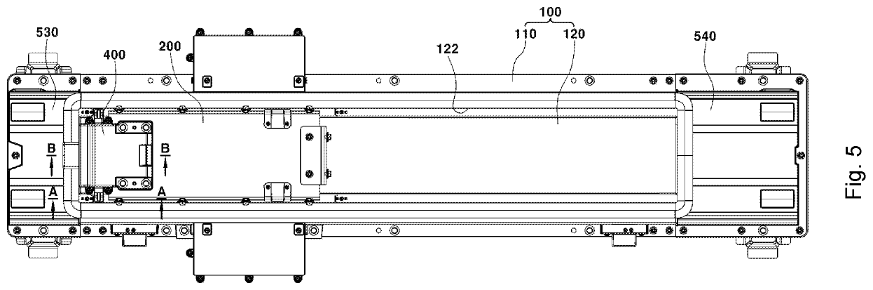

Referring to FIG. 1 to FIG. 5, the sliding device includes a guide rail module 100 configured to guide the sliding and movement of a sliding rail 200, the sliding rail 200 slidably coupled to the guide rail module 100, a rail driving module 300 configured to selectively transmit a driving force for moving the sliding rail 200 to the sliding rail 200, and a sliding mode switching module 400 configured to switch an operation mode and a sliding mode of the sliding rail 200.

The guide rail module 100 is disposed between the driver's seat and the front passenger seat, and includes a guide rail 110 mounted and fixed to a vehicle body. The guide rail 110 has a structure to guide the sliding and linear movement of the sliding rail 200.

The sliding rail 200 is slidably coupled to the guide rail 110 and is configured to linearly move along the guide rail 110. The sliding rail 200 is coupled and fixed to the storage box and is configured to move integrally with the storage box. The sliding rail 200 may move along the guide rail module 100 in the front-rear direction of the vehicle.

The rail driving module 300 is coupled to the sliding rail 200 and is configured to slide and move the sliding rail 200 using the driving force generated by a motor 310.

The sliding rail 200 may be operated in an electric sliding mode by the rail driving module 300. When the sliding rail 200 is operated in the electric sliding mode, the sliding rail 200 may slide along the guide rail module 100 without user intervention.

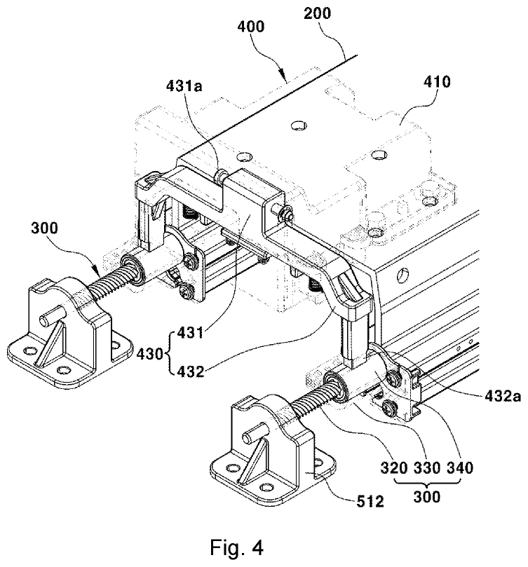

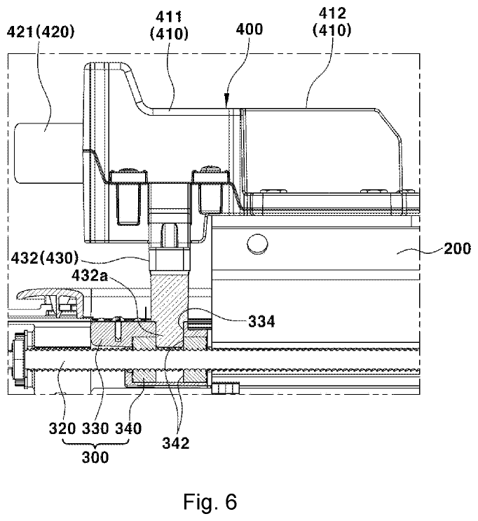

As illustrated in FIG. 4 and FIG. 6, the rail driving module 300 may include a lead screw 320 rotated by the motor 310, a nut housing 330 coupled and fixed to the sliding rail 200, and a linear-movement nut 340 rotatably provided within the nut housing 330.

The nut housing 330 is provided at an end portion of the sliding rail 200 with respect to the movement direction of the sliding rail 200. The end portion of the sliding rail 200 may be provided with a first nut housing 331 and a second nut housing 332.

The linear-movement nut 340 is disposed to be rotatable in place within the nut housing 330. The linear-movement nut 340 is not fixed to the nut housing 330. The linear-movement nut 340 is connected to the lead screw 320 by being engaged therewith within the nut housing 330 and is configured to selectively convert the rotational motion of the lead screw 320 into linear motion. The linear-movement nut 340 is always adjacent to the sliding rail 200 within the nut housing 330. The linear-movement nut 340 selectively transmits the driving force of the motor 310 to the sliding rail 200.

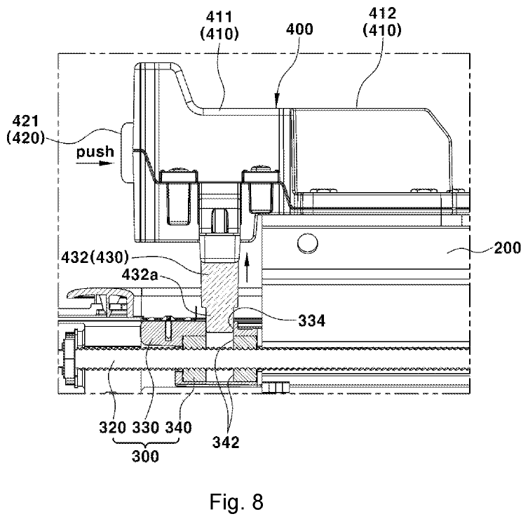

The linear-movement nut 340 converts the rotational motion of the lead screw 320 connected to the motor 310 into linear motion when the rotational motion of the linear-movement nut 340 is restricted and locked by a sliding mode switching module 400 (see FIG. 6). When the rotational motion of the linear-movement nut 340 is not restricted by the sliding mode switching module 400, the linear-movement nut 340 does not convert the rotational motion of the lead screw 320 into linear motion (see FIG. 8). When the lead screw 320 is rotated while the rotational motion of the linear-movement nut 340 is not restricted, the linear-movement nut 340 rotates in place together with the lead screw 320. In other words, when the rotational motion of the linear-movement nut 340 is not locked, the linear-movement nut 340 idles within the nut housing 330. When the rotational motion of the linear-movement nut 340 is locked, the linear-movement nut 340 moves in the length direction of the lead screw 320 while the lead screw 320 is rotated by the motor 310.

The linear-movement nut 340 may have formed therein a locking hole 342 into which a locking rod 430 of the sliding mode switching module 400 is inserted. The locking hole 342 is formed through an axially central portion and one circumferential side portion of the linear-movement nut 340. Moreover, referring to FIG. 6 and FIG. 8, the linear-movement nut 340 may have formed therein a plurality of locking holes 342, and the locking holes 342 may be arranged to be spaced apart in the circumferential direction of the linear-movement nut 340. Accordingly, the rotational motion of the linear-movement nut 340 may be locked by the locking rod 430 at any rotation position.

Furthermore, one circumferential side of the nut housing 330 may have formed therein a through hole 334 through which the locking rod 430, inserted and coupled into the locking hole 342 in the linear-movement nut 340, passes.

The sliding mode switching module 400 is configured to switch the operation mode and the sliding mode of the sliding rail 200 from the electric sliding mode to the manual sliding mode or from the manual sliding mode to the electric sliding mode. To this end, the sliding mode switching module 400 includes a rod housing 410, a push knob 420, and the locking rod 430.

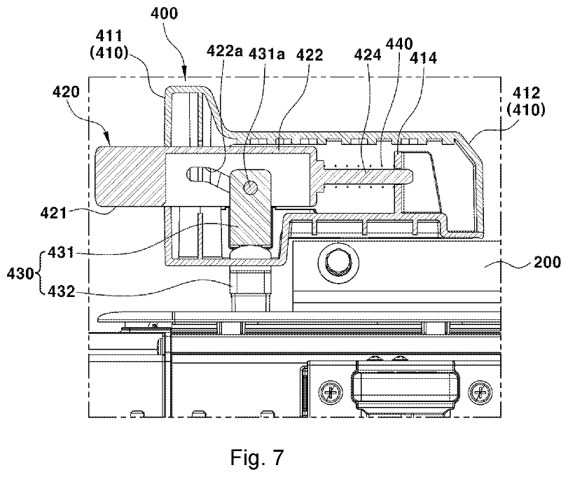

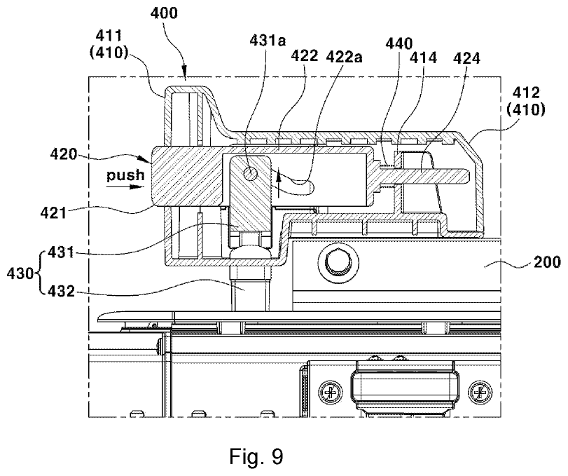

As illustrated in FIG. 7 and FIG. 9, the rod housing 410 is mounted and fixed to the front portion of the sliding rail 200. The rod housing 410 includes a front housing portion 411 not stacked on the front portion of the sliding rail 200, and a rear housing portion 412 stacked on the front portion of the sliding rail 200. The rear housing portion 412 is coupled to the front portion of the sliding rail 200 by being stacked thereon, and the front housing portion 411 protrudes forwardly of the front portion of the sliding rail 200.

The push knob 420 is mounted to the rod housing 410 by being linearly movable in the front-rear direction. The push knob 420 includes a rear knob portion 422 inserted into the rod housing 410, and a front knob portion 421 protruding out of the rod housing 410.

The rear knob portion 422 has a front end provided with a spring assembly bar 424, and the spring assembly bar 424 has a return spring 440 assembled thereto. The spring assembly bar 424 is supported to be linearly movable on a knob support 414 protruding within the internal space in the rod housing 410. The push knob 420 is elastically supported by the return spring 440, so that the front knob portion 421 is kept protruding out of the rod housing 410.

The return spring 440 is disposed between the rear knob portion 422 and the knob support 414. When the push knob 420 is pressed into the rod housing 410 and the front knob portion 421 is inserted into the rod housing 410, the return spring 440 is compressed to generate an elastic restoring force. When the external force pressing the push knob 420 into the rod housing 410 is removed, the push knob 420 returns to the original position thereof by the elastic restoring force of the return spring 440 and the front knob portion 421 returns to protrude out of the rod housing 410.

In order for the locking rod 430 to interlock with the linear movement of the push knob 420, the rear knob portion 422 has formed therein a rod guide hole 422a to guide the up down movement of the locking rod 430 and has formed therein an internal space into which the upper portion of the locking rod 430 is inserted.

The locking rod 430 is assembled to the front housing portion 411 by being movable up and down, and the upper portion of the locking rod 430 is inserted into the rear knob portion 422. The upper portion of the locking rod 430 is provided with a rod guide pin 431a, and the rod guide pin 431a is movably assembled to the rod guide hole 422a in the rear knob portion 422. The locking rod 430 is interlockably connected to the rear knob portion 422 of the push knob 420 via the rod guide pin 431a. The rod guide hole 422a extends to be inclined upward toward the front knob portion 421.

In this embodiment, the locking rod 430 includes a rod head portion 431 provided with the rod guide pin 431a, and a pair of rod leg portions 432 extending horizontally from the left and right sides of the rod head portion 431, respectively, and bent vertically downward. The rod leg portions 432 each have a lower portion passing through the rod housing 410 and disposed outside of the rod housing 410.

Referring to FIG. 7 and FIG. 9, the rod guide pin 431a moves upward along the rod guide hole 422a as the front knob portion 421 is pushed into the rod housing 410. Here, the lower portion of the locking rod 430 is, as illustrated in FIG. 8, detached and separated from the locking hole 342 in the linear-movement nut 340. The lower portion of the locking rod 430 has a locking protrusion 432a detachably inserted into the locking hole 342. Specifically, the lower end of the rod leg portion 432 has the locking protrusion 432a protruding therefrom.

As illustrated in FIG. 6, while the locking protrusion 432a is inserted into the locking hole 342 in the linear-movement nut 340, the linear-movement nut 340 may convert the rotational motion of the lead screw 320 into linear motion and move the sliding rail 200 rearward along the guide rail module 100. Here, the rod guide pin 431a is kept to be disposed at the lower end portion (i.e., first end portion) of the rod guide hole 422a by the spring force of the return spring 440, and the locking rod 430 is kept in a locking mode which restricts the rotational motion of the linear-movement nut 340.

As illustrated in FIG. 8 and FIG. 9, when the front knob portion 421 is inserted into the rod housing 410 by the pressing force of a user acting on the push knob 420, the return spring 440 is compressed, allowing the rod guide pin 431a to be disposed at the upper end portion (i.e., second end portion) of the rod guide hole 422a. Accordingly, the rod head portion 431 of the locking rod 430 is moved upward and the locking protrusion 432a is detached from the locking hole 342 in the linear-movement nut 340, and thus the locking rod 430 enters an unlocking mode which permits the rotational motion of the linear-movement nut 340.

As such, the locking rod 430 moves in a direction detached from the linear-movement nut 340 or moves in a direction coupled to the linear-movement nut 340 by being interlocked with the linear movement of the push knob 420. Specifically, when the front knob portion 421 is pushed into the rod housing 410 by a user, the locking rod 430 moves in the direction detached from the linear-movement nut 340 (i.e., upward direction) to be detached from the linear-movement nut 340 (see FIG. 8 and FIG. 9), and when the front knob portion 421 returns to protrude out of the rod housing 410 by the return spring 440, the locking rod 430 moves in the direction coupled to the linear-movement nut 340 (i.e., downward direction) to be coupled to the linear-movement nut 340 (see FIG. 6 and FIG. 7).

When the locking rod 430 is coupled to the linear-movement nut 340, the rotation force (i.e., driving force) of the motor 310 is transmitted to the sliding rail 200 via the linear-movement nut 340. Conversely, when the locking rod 430 is detached from the linear-movement nut 340, the linear-movement nut 340 rotates together with the lead screw 320 and the driving force of the motor 310 is not transmitted to the sliding rail 200.

While the linear-movement nut 340 is coupled to the locking rod 430, the sliding rail 200 is pressed and pushed in a first direction or the nut housing 330 is pressed and pushed in a second direction depending on the rotation direction of the motor 310. When the nut housing 330 is moved by being pushed by the linear-movement nut 340, the sliding rail 200 moves together with the nut housing 330. The first direction and the second direction are opposite directions. For example, the first direction is a rearward movement direction of the sliding rail 200, and the second direction is a forward movement direction of the sliding rail 200.

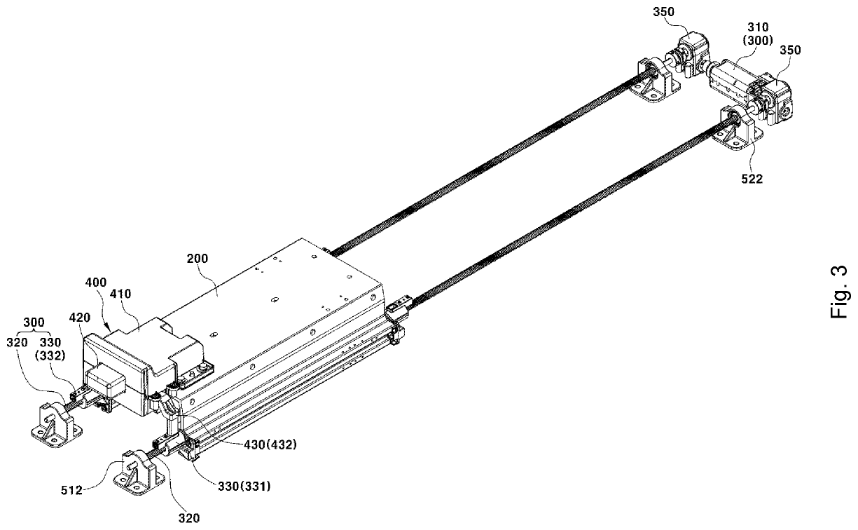

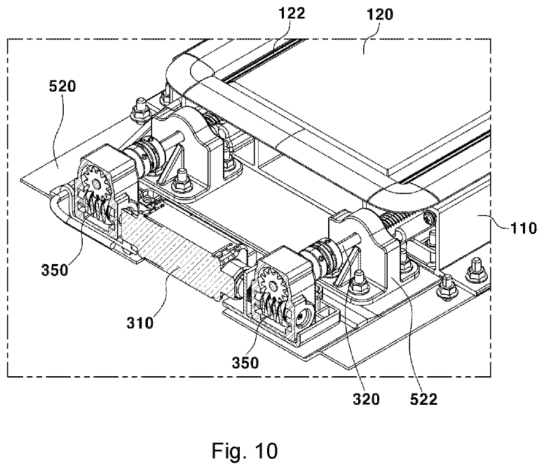

As illustrated in FIG. 3 and FIG. 10, the lead screw 320, provided in a pair, is configured to rotate by receiving the driving force of the motor 310 via a corresponding reducer 350. The motor 310 is connected to the pair of lead screws 320 to transmit power, and the pair of lead screws 320 is arranged in a direction perpendicular to the movement direction of the sliding rail 200 (i.e., left-right direction). The reducer 350 may reduce the rotation speed of the motor 310 and amplify the rotational force (i.e., motor torque) transmitted to the lead screw 320.

The lead screw 320 is rotatably supported in place by a front support 512 and a rear support 522 along with the reducer 350. The front support 512 is mounted to a front plate 510, and the reducer 350 and the rear support 522 are mounted to a rear plate 520. The front plate 510 and the rear plate 520 are mounted to the vehicle body by being adjacent to the guide rail module 100. The front plate 510 and components mounted to the front plate 510 are covered and protected by a front end cover 530. The rear plate 520 and components mounted to the rear plate 520 are covered and protected by a rear end cover 540. The motor 310 is mounted to the rear plate 520 and is protected by the rear end cover 540. Here, the front end cover 530 and the rear end cover 540 cover the opposite end portions of the guide rail module 100, respectively, by being adjacent to the opposite end portions of the guide rail module 100.

The rotation speed and rotation direction of the motor 310 are controlled by a controller provided in the vehicle. The controller may control the driving of the motor 310 based on a signal from a sensor configured to detect the position and movement direction of the sliding rail 200.

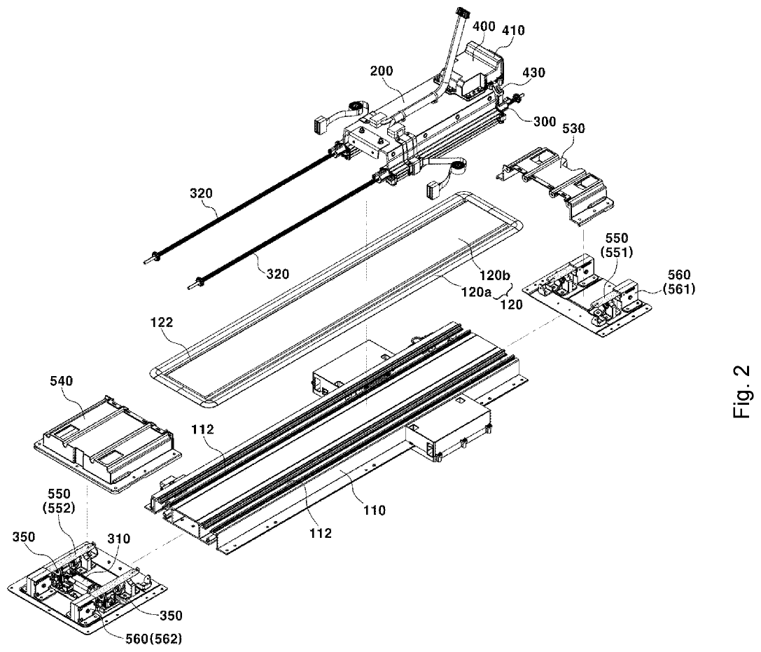

Referring to FIG. 1 and FIG. 2, the guide rail module 100 includes the guide rail 110, and a guide rail cover 120 configured to cover and protect the guide rail 110.

The guide rail 110 is configured to guide the sliding and movement of the sliding rail 200. The guide rail 110 has formed therein a pair of openings 112 into which the lower portion of the sliding rail 200 is slidably inserted.

The guide rail cover 120 is coupled to and supported by the front end cover 530 and the rear end cover 540 so as to be positioned above the guide rail 110. The guide rail cover 120 has formed therein a pair of movement guide holes 122 configured to allow the sliding rail 200 to slide and move. The lower portion of the sliding rail 200 passes through the movement guide holes 122 and is coupled to the guide rail 110.

As illustrated in FIG. 2, in order to couple the sliding rail 200 to the guide rail 110, the guide rail cover 120 may include a first cover portion 120a and a second cover portion 120b. The first cover portion 120a has a plate shape with an open central portion, and the second cover portion 120b is coupled to the first cover portion 120a by being positioned at the central portion of the first cover portion 120a. Here, the pair of movement guide holes 122 is formed between the first cover portion 120a and the second cover portion 120b.

Each of the movement guide holes 122 extends in the movement direction of the sliding rail 200 moving along the guide rail 110. The movement guide hole 122 is positioned above the opening 112, and has a width smaller than that of the opening 112. The movement guide hole 122 has an open section and a closed section changing depending on the movement of the sliding rail 200.

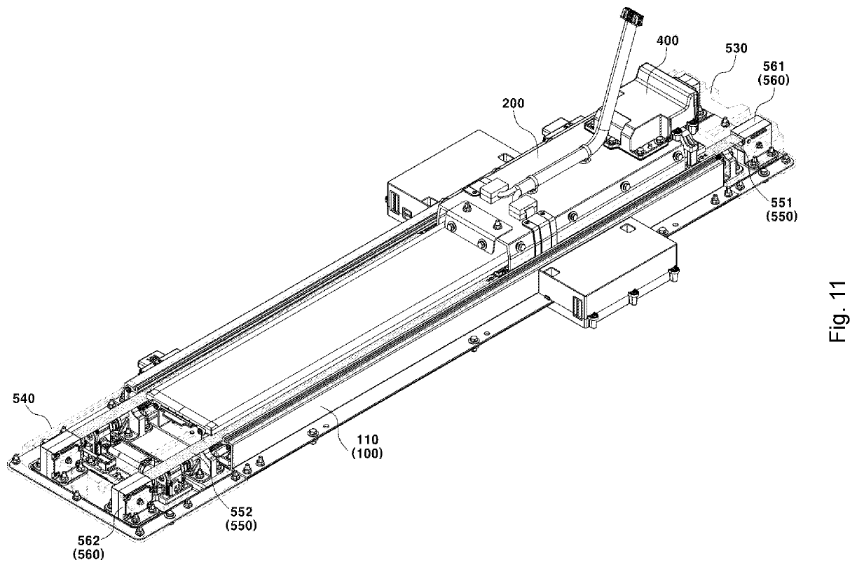

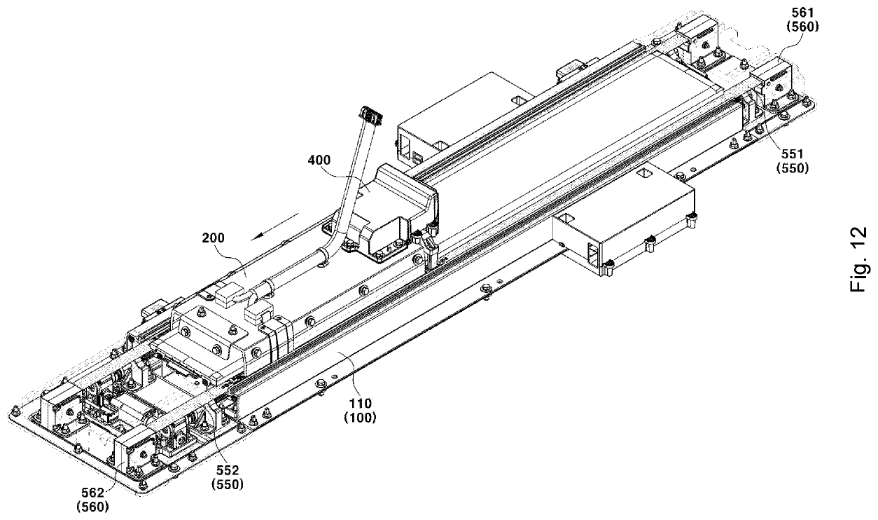

Referring to FIG. 11 and FIG. 12, in order to block foreign matter from entering the guide rail 110, the sliding rail 200 is provided with two pairs of foreign matter blocking springs 550.

Each of the foreign matter blocking springs 550 is configured to prevent foreign matter from entering the guide rail 110 through the open section of the movement guide hole 122. More specifically, the foreign matter blocking spring 550 is configured to close the open section of the movement guide hole 122 that changes depending on the sliding and movement of the sliding rail 200.

To this end, the foreign matter blocking spring 550 has a first end portion coupled and fixed to the end portion of the sliding rail 200, and a second end portion connected to a spring winder 560. The spring winder 560 is provided for each foreign matter blocking spring 550. The spring winder 560 is configured to wind or unwind the foreign matter blocking spring 550 depending on the movement of the sliding rail 200.

The first end portion of the foreign matter blocking spring 550 is one end portion of the foreign matter blocking spring 550 in the length direction thereof, and the second end portion of the foreign matter blocking spring 550 is another end portion of the foreign matter blocking spring 550 in the length direction thereof. A pair of first foreign matter blocking springs 551 is connected to a front end portion of the sliding rail 200, and a pair of second foreign matter blocking springs 552 is connected to a rear end portion of the sliding rail 200. First spring winders 561 are mounted and fixed to the front plate 510, and second spring winders 562 are mounted and fixed to the rear plate 520.

The sliding device of the present disclosure configured as described above allows a user to selectively switch the operation mode of the sliding rail 200 from the electric sliding mode to the manual sliding mode as needed. For example, when the user wants to move the sliding rail 200 and the storage box faster than the movement speed driven by the motor 310, the user may manually move the sliding rail 200 and the storage box while pressing the push knob 420 into the rod housing 410.

Furthermore, the sliding device of the present disclosure may switch the operation mode of the sliding rail 200 regardless of whether the motor 310 is driven or the position of the sliding rail 200. When the operation mode of the sliding rail 200 is switched to the manual sliding mode, the movement speed and movement direction of the sliding rail 200 and the storage box are controlled by the user.

As is apparent from the above description, the present disclosure provides the following effects.

According to the present disclosure, the operation mode of the sliding rail may be switched from the electric sliding mode to the manual sliding mode by a user as needed. For example, when the user wants to move the sliding rail and the storage box faster than the movement speed driven by the motor, the user may manually move the sliding rail and the storage box fast while pressing the push knob into the rod housing.

The effect obtained by the present disclosure is not limited to the effect mentioned above, and other effects not mentioned herein will be clearly understood by those skilled in the art based on the above description.

In addition, in this specification, the terms “front,” “rear,” etc. may be used to describe various components, but the components are not limited to the terms. These terms are used to distinguish one component from another. For example, without departing from the scope of the present disclosure, a front component may be referred to as a first component, and a rear component may be referred to as a second component.

For example, in this specification, the front knob portion 421 may be referred to as “first knob portion,” and the rear knob portion 422 may be referred to as “second knob portion.”

Terms or words used in this specification and claims described below should not be construed as being limited to conventional or dictionary meanings. In addition, the scope of the present disclosure is not limited to the above-described embodiments, and various modifications and improvements by those skilled in the art using the basic concept of the present disclosure as defined in the claims below will also be included in the scope of the present disclosure.

What is claimed is:

1. A sliding device comprising:
a guide rail module;
a sliding rail slidably coupled to the guide rail module;
a rail driving module coupled to the sliding rail and configured to move the sliding rail along the guide rail module; and
a sliding mode switching module configured to switch an operation mode of the sliding rail from an electric sliding mode to a manual sliding mode.

2. The sliding device of claim 1 wherein the sliding mode switching module is configured to switch an operation mode of the sliding rail from an electric sliding mode to a manual sliding mode by blocking a driving force of the rail driving module from being transmitted to the sliding rail.

3. The sliding device of claim 1, wherein the rail driving module comprises:
a lead screw rotated by a motor; and
a linear-movement nut that is rotatable and adjacent to the sliding rail,
wherein in the manual sliding mode, a rotation of the linear-movement nut is interlocked by the sliding mode switching module, and the linear-movement nut is configured to linearly move along the lead screw by being engaged therewith.

4. The sliding device of claim 3, wherein in the electric sliding mode, a rotation of the linear-movement nut is not interlocked by the sliding mode switching module, and the linear-movement nut is configured to rotate together with the lead screw.

5. The sliding device of claim 3, wherein the rail driving module further comprises a nut housing coupled to the sliding rail and within which the linear-movement nut is provided.

6. The sliding device of claim 3, wherein the sliding mode switching module comprises:
a rod housing fixed to the sliding rail;
a push knob mounted in the rod housing and linearly movable into and out of the rod housing; and
a locking rod, connected to the push knob to interlock with the linear movement of the push knob and configured to be detached from or coupled to the linear-movement nut by the linear movement of the push knob.

7. The sliding device of claim 6, wherein pushing the push knob into the rod housing switches the operation mode of the sliding rail to the manual sliding mode.

8. The sliding device of claim 6, wherein being protruded the push knob out of the rod housing switches the operation mode of the sliding rail to the electric sliding mode.

9. The sliding device of claim 6, wherein:
the push knob is provided with a rod guide hole to guide a vertical movement of the locking rod, and
the locking rod is provided with a rod guide pin configured to move along the rod guide hole by the linear movement of the push knob.

10. The sliding device of claim 9, wherein:
the push knob comprises a first knob portion protruding out of the rod housing, and a second knob portion inserted into the rod housing, and
the rod guide hole is provided in the second knob portion.

11. The sliding device of claim 9, wherein the rod guide hole extends to be inclined upward toward the first knob portion.

12. The sliding device of claim 6, wherein the linear-movement nut is provided with a locking hole into which the locking rod is coupled.

13. The sliding device of claim 12, wherein the locking rod has a lower portion provided with a locking protrusion detachably inserted into the locking hole so as not to restrict the rotation of the linear-movement nut while the locking protrusion is detached from the locking hole.

14. The sliding device of claim 13, wherein pushing the push knob into the rod housing detaches the locking protrusion from the locking hole, thereby switching the operation mode of the sliding rail to the manual sliding mode.

15. The sliding device of claim 9, wherein a return spring is provided between the second knob portion and the rod housing, and is compressed as the first knob portion moves into the rod housing.

16. The sliding device of claim 15, wherein releasing the push knob returns the push knob by the return spring, thereby switching the operation mode of the sliding rail to the electric sliding mode.

17. The sliding device of claim 1, wherein the guide rail module comprises:
a guide rail mounted to a vehicle body and configured to guide a movement of the sliding rail; and
a guide rail cover configured to cover the guide rail and having a movement guide hole to allow the sliding rail to move.

18. The sliding device of claim 17, wherein the sliding rail has a foreign matter blocking spring coupled thereto, and wherein the foreign matter blocking spring is configured to close the movement guide hole opened by the movement of the sliding rail.

19. The sliding device of claim 1, wherein in the electric sliding mode, the sliding rail is configured to be electrically moved by the rail driving module along the guide rail module.

20. The sliding device of claim 1, wherein in the manual sliding mode, the sliding rail is configured to be manually moved along the guide rail module by a user.
